(19) United States
(12) Patent Application Publication
(10) Pub. No.: US 2017/0079264 A1
(43) Pub. Date: Mar. 23, 2017

(54) COATING ANTIMICROBIC FILM COMPOSITIONS

(71) Applicant: PAVIA FARMACEUTICI S.R.L., Copiano (IT)

(72) Inventors: Massimo FERRARI, Copiano (IT); Carlo Alberto BIGNOZZI, Ferrara (IT); Giuliana DI LALLO, Massa Macinaia (IT); Valeria DISSETTE, Occhiobello (IT)

(21) Appl. No.: 15/311,469

(22) PCT Filed: May 27, 2014
(86) PCT No.: PCT/IT2014/000146

§ 371 Date: Nov. 15, 2016

(51) Int. Cl. A01N 25/10; A01N 47/08; A01N 33/12; C09D 5/14; B65D 81/24; C09D 175/04; A61J 1/00; A45C 11/00; B65D 25/14; B65D 25/34; A01N 59/16; C09D 133/00

(52) U.S. Cl. CPC A01N 25/10; A01N 59/16; A01N 47/08; A01N 33/12; C09D 5/14; C09D 133/00; C09D 175/04; A61J 1/00; A45C 11/005; B65D 25/14; B65D 25/34; B65D 81/24

(57) ABSTRACT

The invention relates to an aqueous composition useful for producing antimicrobic polymer films, comprising at least an anionic silver complex, one or more cationic organic components with microbicidal activity, a solvent and a polymeric component. Said antimicrobic films can be obtained by depositing the aqueous composition of the invention on the surface to be treated, possibly followed by a thermosetting or photocuring treatment. The antimicrobic polymer films can be produced on surfaces of containers made of plastic, glass, ceramic or metallic material, thereby ensuring a barrier effect which protects the treated surface from invasions of external microbial agents borne by the air or hands of workers who use such containers.

The invention relates in general terms to an aqueous composition for producing antimicrobic polymer films, comprising at least a silver complex, one or more cationic organic components with microbicidal activity, a solvent and a polymeric component.

### PRIOR ART

The creation of antibacterial surfaces represents a major target to be achieved in various sectors and environments. In particular, in the medical, health care and pharmaceutical fields, the possibility of obtaining solid surfaces treated with antibacterial compositions capable of remaining stable over time has been the subject of continuous research and improvements aimed at obtaining antibacterial compositions capable of being applied on the surfaces concerned.

One need only consider that in the practice of social antisepsis of the hands with alcoholic formulations a health care worker comes repeatedly into direct contact with the exterior surfaces of various containers which, if not adequately protected against microbial contaminations, can become sources of transmission rather than means of interrupting infections. Among the problems encountered, however, mention needs to be made of the difficulties of application which is at times associated with some antibacterial compositions, the homogeneity of application and, not least of all, the exiguous duration of action that some compositions have.

The applicant has now found an antibacterial composition capable of being applied on substantially any type of solid surface and being then converted into a protective film which maintains the antibacterial characteristics of the initial composition. In this manner, the treated surface will be antibacterial and also capable of maintaining this characteristic over time for prolonged periods. Advantageously, the present invention has application above all in the production of sterile and/or antibacterial containers for pharmaceutical use, as well as for applications in the medical field in general, as better described here below.

### SUMMARY OF THE INVENTION

In a first aspect, the invention relates to an aqueous composition comprising at least:
a monovalent anionic silver complex of formula (I):

Ag+---[L1−M+] (I)

wherein the unit [L1−M+], coordinated with the silver ion, has the general formula:

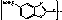

wherein:
X is selected from among the groups: —NH—, —O—, —S— and —NR—; where R represents a straight or branched alkyl chain C1-C6 (C1-C6Alk), or a straight or branched carbonyl-C1-C6 (—C(O)—C1-C6Alk), preferably an acyl group, (—C(O)—CH3);
M+ represents the hydrogen ion (H+) or the ion of an alkaline metal, preferably the sodium ion (Na+);
   one or more cations with antimicrobic activity;
   a polymeric component selected from among: fibers, thermoplastic, thermosettable, photocurable and elastomeric components; and
characterized in that it contains propylene carbonate.

In a second aspect, the invention relates to the above-mentioned aqueous composition in the form of a polymeric film, preferably obtained by thermal or optical irradiation of said aqueous composition.

A further aspect is the use of the present aqueous composition, preferably in the form of a film, as an antibacterial agent for surfaces.

In an additional aspect, the invention relates to a process for preparing surfaces coated with the antibacterial composition in the form of a film, said process comprising:

putting the surface to be treated in contact with the above-mentioned aqueous composition; and

subjecting the coated surface to a curing treatment, preferably by means of a thermosetting or photocuring treatment.

In one aspect thereof, the invention also relates to a surface or an object coated with the composition of the invention, preferably in the form of a film.

### DESCRIPTION OF THE FIGURES

FIG. 1: schematic representation of the surface of a polymeric film of the invention.

FIG. 2: example of antimicrobic activity of an acrylic polymer film of the invention, containing PHMB-Ag.

### DETAILED DESCRIPTION

Unless otherwise specified, the term % by weight (% w/w) indicates the percentage by weight of the single component relative to the total weight of the aqueous composition.

The term C₁-C₆ alkyl (C₁-C₆Alk) indicates a straight or branched alkyl group, possibly substituted, comprising from 1 to 6 carbon atoms, for example selected from among methyl, ethyl, propyl, butyl, isobutyl and the like.

The object of the present invention is to provide a composition for preparing a filmogenic coating, typically for outer and/or inner surfaces of a container, so as to obtain an aseptic state that lasts over time, substantially irrespective of the environmental conditions and the number of times it is handled. This characteristic is required in all settings, for example industrial, medical, food processing and veterinary settings and those of the collectivity, where it is important to interrupt the chain of transmission of infections through the handling of any container. It becomes extremely useful in intensive care departments and in other critical departments in a health care and hospital setting, where besides the environmental conditions and devices used, the outer surface of the containers of medications or products used in those environments, including products in liquid or solid form, require a controlled degree of microbial contamination to interrupt the transmission of infections.

Advantageously, the antibacterial aqueous composition of the present invention can be applied on surfaces, for example, of pharmaceutical containers, using known methods, such as spraying or immersion, without substantially modifying the industrial application processes. The applicants have in fact observed that it is possible to obtain a perfect adhesion, on the treated surface, of an invisible filmogenic layer which acts as an antimicrobic barrier resistant over time and is made with the present antibacterial aqueous composition. In this manner, the degree of microbial contamination on the surface can be considerably reduced and maintained permanently at low levels, thus decreasing the probability of transmission of infections therethrough.

As mentioned above, the present antibacterial aqueous composition comprises at least a monovalent silver complex of formula (I):

Ag+--[L1−M+] (I),

wherein the unit [L1−M+], coordinated with the silver ion, has the general formula:

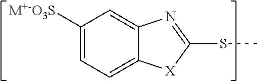

wherein X and M+ are defined as above.

The group [L1−M+] is preferably selected from among: 2-mercapto-5-benzimidazole sulfonic acid (L′) and the sodium salt thereof (L″), and 2-mercapto-5-benzooxazole sulfonic acid (L′″), having the following formulas:

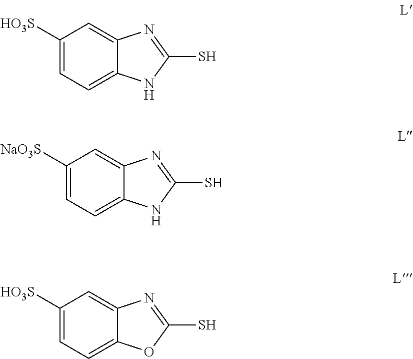

The monovalent silver complex of formula (I) can thus be represented by the following general formula:

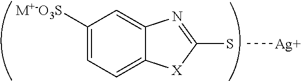

where the broken line indicates the coordinate bond between the ion Ag⁺ and the mercapto group of the unit [L1−M+], and where X and M+ are defined as above.

Said complex can be prepared as described, for example, in international patent application PCT/IB2013/054649, i.e. by dissolution of the suitable thiolic binder L in water, followed by the addition of a silver salt, preferably silver nitrate. In this manner, the ion Ag⁺ is capable of coordinately bonding to the thiolic sulfur of the binder, forming the complex of formula (I) in an aqueous solution that is stable over time.

Advantageously, said complex is capable of achieving a synergy of action with the organic cation with antibacterial action present as a component of the composition of the invention. In this regard, preferred antibacterial cations are selected from among: chlorhexidine acetate or gluconate, didecyl dimethyl ammonium chloride (DDA), polyhexamethylene biguanide (PHMB) or mixtures thereof. Particularly preferred is a composition comprising PHMB, useful for preparing the composition in the form of a polymeric film. The applicants have in fact noted that the terminal cyanoguanidine group of PHMB enables anchorage to the polymer skeleton in a manner that is stable and effective over time.

The chloride or bromide salts of DDA are equally preferred.

In one embodiment, the present composition comprises both DDA and chlorhexidine, preferably chloride or bromide salt and digluconate respectively.

Advantageously, the synergic effect of the silver complex (I) and of the cation with antimicrobic activity of the composition of the invention is also maintained in the event that the composition of the invention is converted into a protective film, as supported by the experimental part included herein. In this manner, it is possible to increase the bactericidal action of the silver complex, obtaining excellent results also in terms of stability and durability of the composition applied to a solid surface.

Preferably, the silver complex and antibacterial cation compound are present in a mutual ratio by weight of between 1:1 and 1:150.

The polymeric component of the present composition can be selected from among: fibers, thermoplastic, thermosettable, photocurable and elastomeric components.

Preferably, said component is a photocurable polymer, even more preferably an acrylic one, for example acrylate, polyacrylonitrile, methacrylate and the like.

Equally preferred are thermosettable polymers, even more preferably selected from among: polyurethane, epoxy resin, polyphenol, polydicyclopentadiene and polyamide.

The peculiar photochemical stability of the anionic silver complex and the synergy of effect with the organic cation make this mixture particularly preferred for producing mixtures with acrylic polymers, or with polyurethane polymers, transformable into films by means of UV photo-irradiation. The mixture is moreover suitable for producing polymeric films obtainable by mixing with other polymeric systems, for example systems selected from among: fibers such as Nylon-6, Nylon-10, Nylon-6,6, polyethylene terephthalate, polyethylene, polyvinyl chloride, polypropylene, polyvinylidene chloride, Teflon, polyvinyl alcohol; polymer systems commonly employed as plastics such as: high and low density polyethylene, polytetrafluoroethylene, polystyrene, polycarbonates polymethylmethacrylate, and with polymer systems commonly employed as elastomers, such as, for example polyisoprene cis (natural rubber), polybutadiene, butyl polychloroprene rubber (neoprene) and silicone, and with siloxane polymers.

Preferably, the polymeric component is present in the composition of the invention in an amount comprised between 40 and 90% w/w, more preferably between 60 and 80% w/w.

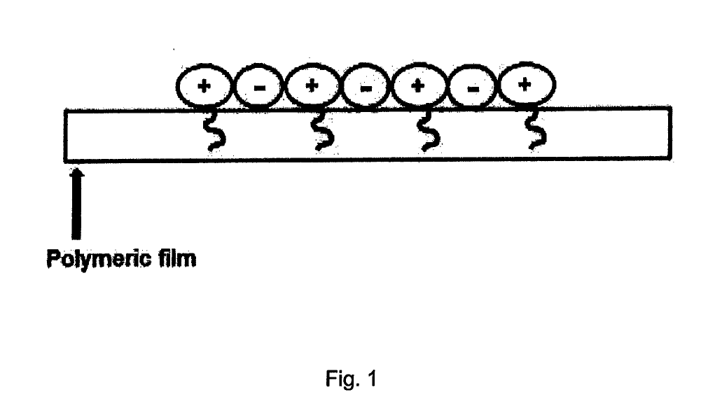

As schematically indicated in FIG. 1, the polar ionic nature of the adduct between the silver complex of formula (I), negatively charged, and the organic component with antimicrobic activity, positively charged, promotes a phase separation with the non-polar polymeric mixture (or mixture with a lower polarity), causing the polar ionic components to rise to the surface of a polymeric film. However, such components remain anchored to the surface thanks to the presence of alkyl chains, as in the case of didecyl dimethyl ammonium chloride (DDA), or of the phenyl groups present in the chlorhexidine cation, or of polyhexamethylene biguanide (PHMB), which show similarities in terms of polymeric skeletons.

For this purpose, using the cationic species PHMB is convenient, since the terminal cyanoguanidine group enables anchorage to the polymeric skeleton in a manner that is particularly effective and stable over time.

In order better to produce stable solutions with a high antimicrobic power of the ionic pair formed by the anionic silver complex and the cationic organic component, it is advisable to use a stabilizing solvent that simultaneously enables intimate mixing with the polymer phase required for the formation of the film.

In this respect, the applicant has surprisingly found that propylene carbonate enables an intimate solubilization of all components of the aqueous mixture of the invention, without altering the properties of the polymeric component used to obtain the present composition in the form of a protective film as described here in detail.

Propylene carbonate (CAS No. 108-32-7) is a polar aprotic compound of formula (III):

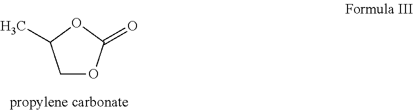

It is normally used as a nontoxic solvent in a series of applications, for example in both the electrochemical and cosmetic fields (for a reference in general, see, for example, CRC Handbook of Chemistry and Physics, 92ed).

In a preferred embodiment, the aqueous composition of the invention comprises propylene carbonate in an amount comprised between about 30% and 60% % w/w, more preferably between 40 and 50% w/w.

It should be noted that particular advantages in terms of antibacterial activity and durability can be obtained by appropriately mixing the amount of water and of propylene carbonate. In one embodiment, the composition of the invention comprises water and propylene carbonate in a ratio of between 0.6 and 0.9.

The aqueous composition of the invention is prepared by mixing together the various components in the presence of an aqueous solvent medium. The aqueous solution obtained is substantially clear and devoid of particles settling on the bottom and/or precipitates. In one embodiment, the silver complex, the selected antibacterial cationic component and the propylene carbonate are mixed together in water, in such a way as to form an aqueous solution, as illustrated in this experimental part. The solution obtained by mixing water, the complex (I), the antibacterial cation and propylene carbonate is used in the composition of the invention preferably in an amount comprised between about 3% and 7% w/w, even more preferably between about 4% w/w and 5% w/w. Preferably, distilled water is used, even more preferably in an amount comprised between 35-40% w/w.

Said solution is then mixed with the suitable polymeric component and put in contact with the surface to be treated, for example by spray coating, spin coating, immersion or similar techniques.

According to the polymeric component selected, the film can be produced stably by photo- or thermo-irradiation.

Therefore, in a further aspect, the invention relates to a process for producing coated surfaces, which comprises contact of the surface to be treated with the antibacterial aqueous composition of the invention, followed by a thermal or irradiation treatment, to enable the solidification of the composition in the form of an antibacterial film.

Depending on the type of polymeric component, the solidification treatment will take place by heating or by irradiation. In the former case, the preferred temperatures are comprised between about 30° C. and 120° C., preferably between about 60° C. and 80° C., obtainable by using ovens or lamps known in the art.

In the case of photocurable polymers, the irradiation will preferably take place with the use of UV or IR lamps, even more preferably with wavelengths comprised between about 200 nm and 350 nm, values comprised between about 250 nm and 320 nm being particularly preferred. Advantageously, said treatment can be applied to any type of surface, for example, cardboard, glass, plastic, porcelain, steel or another metal or metal alloys. The composition of the invention can be applied both on the surface (for example outer surface) of a container, or on the surface of the material prior to molding (for example in the form of sheets) which will then be used to produce a container, for example, in the form of a tube. In this manner, it is possible to coat both the outer and inner surfaces of the container that will be formed after the application of the composition and formation of the polymeric film.

In an additional aspect, the invention relates to a surface coated with the composition of the invention, preferably in the form of a film as described above. Preferably, said film has a thickness comprised between about 0.2 microns and 8 microns (μm), more preferably between about 1 micron and 5 microns (μm).

The present antibacterial aqueous composition can substantially be applied to any type of solid material, and does not interfere negatively with the nature of the material concerned, which substantially retains, unchanged, its physicochemical and mechanical characteristics. In a preferred embodiment, the composition of the invention is applied as a film on the inner and/or outer surfaces of packaging intended to contain pharmaceutical preparations or intended for the treatment or preservation of contact lenses. Preferred containers coated with the composition of the invention in the form of a film are antiseptic or disinfectant containers, even more preferably intended to contain formulations declared to be sterile.

The present composition can moreover be applied on surfaces of mobile telephone apparatus, on which the presence of considerable concentrations of different bacterial species has been found, including Pseudomonas aeruginosa, Staphylococcus aureus and Escherichia coli. The examples that follow describe in detail the preparation of the antimicrobic solutions, the methods of application on a solid substrate and the antimicrobic activity of the surface thereof.

### EXPERIMENTAL PART

### Example 1

### Aqueous Solution Comprising Silver Complex (I), DDA and Propylene Carbonate

150 g of DDA is mixed with 50 g of distilled water and with 350 g of propylene carbonate. After dissolution, 0.57 g of 2-mercaptobenzimidazole-5 sulfonate sodium salt dissolved in 50 g of distilled water and 0.34 g of AgNO₃ dissolved in 50 g of distilled water are added.

The resulting antimicrobic solution has the following composition by weight: DDA 23%; Ag 0.033%, Propylene carbonate 54%.

### Example 2

### Aqueous Solution Comprising Silver Complex (I), PHMB and Propylene Carbonate

150 g of PHMB is dissolved at 60° C. in a solvent compound with 200 g of distilled water and with 350 g of propylene carbonate. After about 30 min, 0.57 g of 2-mercaptobenzimidazole-5 sulfonate sodium salt dissolved in 50 g of distilled water and 0.34 g of AgNO₃ dissolved in 50 g of distilled water are added.

The resulting antimicrobic solution has the following composition by weight: PHMB 18.8%; Ag 0.027%, Propylene carbonate 44%.

### Example 3

### Aqueous Solution Comprising Silver Complex (I), DDA, Chlorhexidine Digluconate (CH) and Propylene Carbonate

150 g of DDA is mixed with 50 g of distilled water and with 350 g of propylene carbonate. After dissolution, 0.57 g of 2-mercaptobenzimidazole-5 sulfonate sodium salt dissolved in 50 g of distilled water and 0.34 g of AgNO₃ dissolved in 50 g of distilled water are added. Finally, 100 g of chlorhexidine digluconate soluble in water to 20% is added.

The resulting antimicrobic solution has the following composition by weight: DDA 20%; Ag 0.022%, Chlorhexidine 2.7%, Propylene carbonate 47%.

### Example 4

### Preparation of Surfaces Coated with Polymeric Films of the Invention

The antimicrobic solutions described in Examples 1-3 were mixed in percentages of 4-5% with photopolymerizable acrylic-based lacquers or polyurethane paints.

The polymeric mixtures were then applied by spray coating or spin coating on surfaces of different materials, namely, polyethylene, polypropylene, steel and glass in the case of photopolymerizable acrylic polymers and wood in the case of the polyurethane mixture.

Once a film of a thickness in the range of 2-5 microns was deposited, the photopolymerizable acrylate-based compositions were subjected to UV irradiation in the wavelength range of 250-320 nm, whilst the polyurethane-based films were heated at 80° C. until complete solidification.

### Example 5

### Antimicrobic Activity of Polymeric Films of the Invention

The surfaces of the materials obtained from Example 4 were then contaminated with a microbial pool of a concentration in the range of 1.5×10⁶-5.0×10⁶ CFU/ml.

In the various tests of antimicrobic activity, both the treated samples and control samples treated with normal polymers were placed in contact with a mixture of Gram-positive and Gram-negative bacteria and yeast for a period of 30 minutes. Once this time had elapsed, the residual microbial count was evaluated with Plate Count Agar (PCA) Contact plates, containing a non-selective medium.

The following test strains were used:

| | |
|---|---|
| Staphilococcus aureus | ATCC 6538 |
| Escherichia coli | ATCC 10536 |
| Pseudomonas aeruginosa | ATCC 15442 |
| Enterococcus hirae | ATCC 10541 |
| Candida albicans | ATCC 10231 |

The bacteria came from the Department of Experimental and Diagnostic Medicine, Microbiology Section, of the University of Ferrara, and were purchased from International PBI S.p.A.

The bacterial strains were kept frozen in a culture broth and 50% glycerol (v/v); prior to use, they were transplanted on TSA (Tryptone Soya Agar) slants and refrigerated at 4° C.±2° C. Once thawed, the bacterial strains were transplanted twice on TSA slants and incubated at 37° C.±1° C. for 18 hours to obtain the working culture. Within 2 hours from the beginning of the test the working culture was suspended in a diluent (tryptone water) using glass beads and the suspension was diluted until obtaining a concentration in the interval of 1.5×10⁶-5.0×10⁶ CFU/ml.

For each strain of microorganisms, a test tube containing 5 ml of test suspension having a concentration between 1.5×10⁶ and 5.0×10⁶ CFU/ml was prepared. 1 ml of suspension was drawn from each test suspension and placed in a single test tube, which thus contained a mixture of all the microorganisms considered (test mixture).

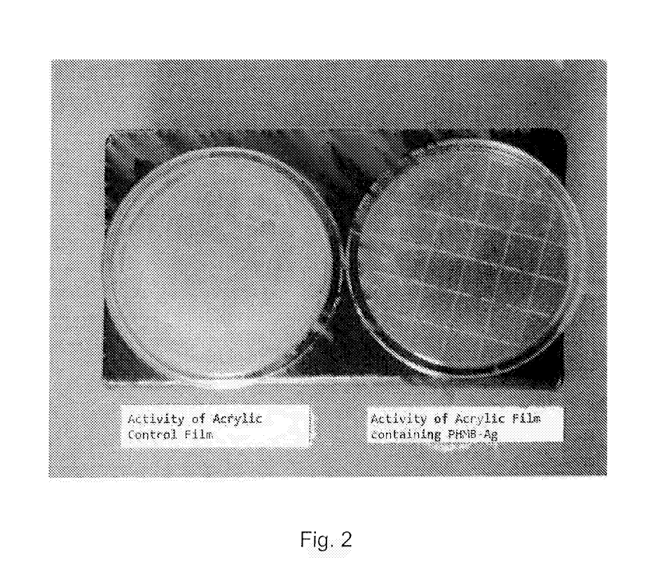

In all the experiments performed, the treated samples and controls were placed in contact with 100 μl of the test mixture, evenly distributed in an area corresponding to the surface of a PCA contact plate (24 cm²). After a contact time of 30 minutes, the contaminated surfaces were sampled with the contact plates, containing a non-selective medium and without an inactivant. The contaminated plates were then placed in an incubation cell at 37° C. for 24 hours. After this time had elapsed, the plates were examined to assess the development of bacterial colonies.

Whereas the control samples treated with normal polymeric compositions showed a continuous layer of microbial colonies, the samples treated with polymeric mixtures to which the DDA-Ag, PHMB-Ag or DDA-Ag—CH antimicrobic solutions were added did not show any microbial colony. The films thus obtained are capable of reducing the applied microbial load by at least 5 logarithms, irrespective of the material the polymeric film is deposited on. From FIG. 2 it may be seen that a continuous layer of microorganisms is visible in the control, whereas no microbial colony can be noted on the polymeric film treated with the composition of the invention containing PHMB-Ag.

### Example 6

### Stability Test

The samples of coated surfaces of example 4 were washed in water for a period of 60 min and subjected to the microbiological analyses described above. In all cases the reduction in the microbial count remained in the range of 3-4 logs.

1. An aqueous composition comprising:
a monovalent anionic silver complex of formula (I):
Ag+---[L1−M+] (I)
wherein the unit [L1−M+], coordinated with the silver ion, has the general formula: 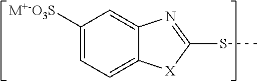
wherein:
X is selected from the group consisting of —NH—, —O—, —S— and —NR—; where R represents a straight or branched C₁-C₆ alkyl group, or a straight or branched carbonyl-C₁-C₆ alkyl group;
M+ represents the hydrogen ion (H+) or the ion of an alkaline metal;
one or more cations with antimicrobic activity;
a polymeric component that is: a polymer fiber, thermoplastic, thermosettable, photocurable, and/or elastomeric; and
propylene carbonate.

2. The composition according to claim 1, wherein the polymeric component is photocurable or thermosettable.

3. The composition according to claim 2, wherein the polymeric component is photocurable by UV irradiation.

4. The composition according to claim 1, wherein the polymeric component is an acrylic, acrylate, polyacrylonitrile, methacrylate, polyurethane, epoxy resin, polyphenol, polydicyclopentadiene, polyamide, or combinations thereof.

5. The composition according to claim 1, wherein the polymeric component is present in an amount from 40 to 90% w/w.

6. The composition according to claim 1, wherein the group [L1−M+] is 2-mercapto-5-benzimidazole sulfonic acid, the sodium salt of 2-mercapto-5-benzimidazole sulfonic acid, or 2-mercapto-5-benzooxazole sulfonic acid.

7. The composition according to claim 1, wherein said cation with antimicrobic activity is a salt selected from the group consisting of DDA, PHMB, chlorhexidine and mixtures thereof.

8. The composition according to claim 1, wherein the propylene carbonate is present in an amount from 30 to 60% w/w.

9. A polymeric film comprising the composition of claim 1.

10. The film according to claim 9, wherein the polymeric film has a thickness ranging from 0.2 microns to 8 microns.

11. A method of using the composition according to claim 1 as an antibacterial agent for solid surfaces, comprising the step of applying the composition of claim 1 to a solid surface to impart antibacterial properties on said solid surface.

12. The method according to claim 11, wherein the solid surface is an inner or outer wall of a container suitable for food, pharmaceutical, health care or medical use.

13. A container internally and/or externally coated with the composition according to claim 1.

14. A process for coating a solid surface with the composition according to claim 1, comprising contacting said surface with said composition, followed by photo- or thermo-irradiation.

15. The composition according to claim 1, wherein the carbonyl-C₁-C₆ alkyl group is an acyl group.

16. The composition according to claim 1, wherein the ion of an alkaline metal is the sodium ion (Na⁺).

17. The composition according to claim 5, wherein the polymeric component is present in an amount from 60 to 80% w/w.

18. The composition according to claim 10, wherein polymeric film has a thickness ranging from 1 micron to 5 microns.

19. The container according to claim 13, wherein the container is used to house drugs or contact lenses.

20. The process according to claim 14, wherein the photo- or thermo-irradiation is UV irradiation.
